(19) United States
(12) Patent Application Publication
(10) Pub. No.: US 2023/0018707 A1
(43) Pub. Date: Jan. 19, 2023

(54) DATA REBALANCING IN DATA STORAGE SYSTEMS

(71) Applicant: Seagate Technology LLC, Fremont, CA (US)

(72) Inventors: Shankar Tukaram More, Pune (IN); Ujjwal Lanjewar, Pune (IN); Sachin Chandrakant Punadikar, Pune (IN)

(21) Appl. No.: 17/377,999

(22) Filed: Jul. 16, 2021

(51) Int. Cl. G06F 3/06

(52) U.S. Cl. CPC G06F 3/0631; G06F 3/0635; G06F 3/0659; G06F 3/0604; G06F 3/0683; G06F 3/067

(57) ABSTRACT

A method includes adding new storage capacity to a data storage system, which has a pre-existing storage capacity. The method further includes rebalancing data from the pre-existing storage capacity to the new storage capacity in connection with a non-rebalancing operation performed on the pre-existing storage capacity.

### SUMMARY

In certain embodiments, a method includes adding new storage capacity to a data storage system, which has a pre-existing storage capacity. The method further includes rebalancing data from the pre-existing storage capacity to the new storage capacity in connection with a non-rebalancing operation performed on the pre-existing storage capacity.

In certain embodiments, a non-transitory computer readable medium storing code representing a plurality of processor-executable instructions, the code comprising code to cause a processor to: rebalance data from pre-existing storage capacity to new storage capacity in connection with a non-rebalancing operation performed on the pre-existing storage capacity.

In certain embodiments, data storage system includes pre-existing data storage capacity, new data storage capacity, and control circuitry including logic programmed to rebalance data from the pre-existing data storage capacity to the new data storage capacity in connection with a non-rebalancing operation performed on the pre-existing data storage capacity.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIGS. 1A-1C show a data storage sub-system, in accordance with certain embodiments of the present disclosure.

FIG. 2 shows a schematic of a data storage system that includes a data storage sub-system and a data storage control system, in accordance with certain embodiments of the present disclosure.

FIGS. 3-9 show flowchart diagrams of various methods for rebalancing data within the data storage system, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope of the appended claims.

### DETAILED DESCRIPTION

The demand for data storage services continues to grow, resulting in vast amounts of data being stored to data storage systems in private clouds and public clouds. To meet increased demand, more capacity can be added to a given data storage system. For example, a new storage unit or node can be added to a data storage system to increase capacity of that data storage system. Adding more capacity typically requires that the data stored within the data storage system be rebalanced among its various storage units or nodes. However, rebalancing data can consume bandwidth and therefore degrade performance of the data storage system. Certain embodiments of the present disclosure are accordingly directed to approaches for rebalancing data in data storage systems.

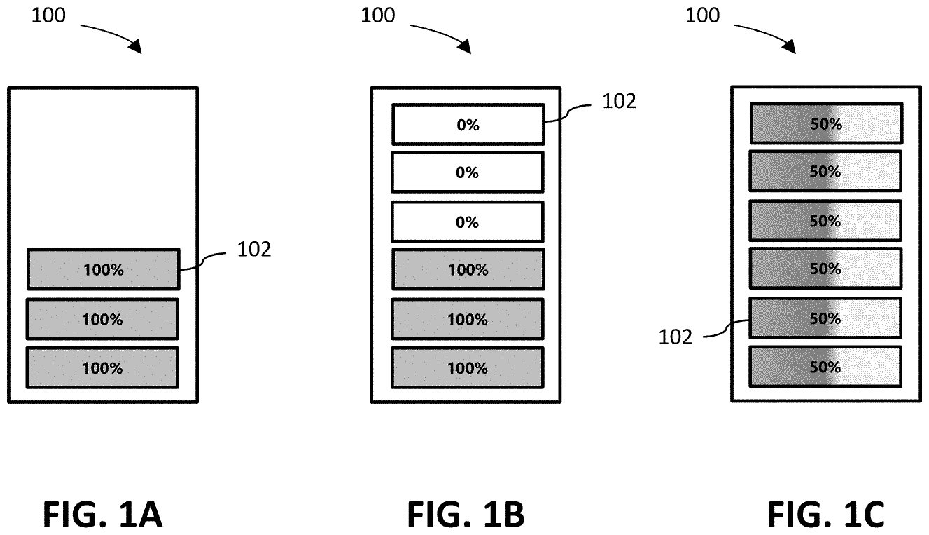

FIG. 1A shows a data storage sub-system 100 that includes storage units 102. In certain embodiments, the data storage sub-system 100 is a server that includes a rack with multiple enclosures (e.g., drawers) that act as the storage units 102. Additionally or alternatively, the data storage sub-system 100 is subset of the enclosures of a server, or the data storage sub-system 100 encompasses multiple separate servers each with their own set of enclosures. In certain embodiments, the storage units 102 are enclosures that include multiple individual data storage devices such as hard disk drives and/or solid state drives. Additionally or alternatively, the storage units 102 are software-defined storage nodes that represent separate virtual data storage units.

FIG. 1A shows the data storage sub-system 100 initially including three storage units 102. In FIG. 1A, the three storage units 102 are at 100% capacity such that they cannot store additional data. To add more capacity to the data storage sub-system 100, additional storage units 102 can be added. For example, adding capacity can involve physically adding storage units to a server and/or adding new software-defined storage nodes to the data storage sub-system 100 that are physically separate from a given server.

FIG. 1B shows the data storage sub-system 100 with three additional storage units 102. When the additional storage units 102 are added, the new storage units have used little to none of their available storage capacity. As such, the data within the data storage sub-system 100 in FIG. 1B can be considered to be unbalanced because the stored data is concentrated in a subset of storage units 102 of the data storage sub-system 100.

FIG. 1C shows the data storage sub-system 100 with data balanced among the system's storage units 102. In the example of FIG. 1C, each storage unit 102 is filled to 50% of their storage capacity. As such, in the example of FIG. 1C, the stored data is distributed equally among the storage units 102. Rebalancing data can result in unequal but similar distribution of data among the storage units 102.

One problem with rebalancing data when new capacity is added to the data storage sub-system 100 is that rebalancing operations consume bandwidth or resources of the data storage sub-system 100. For example, rebalancing data uses bandwidth or resources that otherwise would be available to process incoming read commands and write commands. As such, rebalancing data can degrade performance of the data storage sub-system 100.

However, delaying rebalancing data (e.g., delaying until the data storage sub-system 100 is otherwise idle) carries its own risk. For example, if data is concentrated in a subset of storage units 102 and one or more of those storage units 102 malfunctions before data can be rebalanced to other storage units 102, data storage may be temporarily unavailable (e.g., for write operations involving new data). Another issue with delaying rebalancing data is that capacity can be lost and make it challenging to efficiently scale up capacity. For example, the fuller the existing storage units 102 are when a new storage unit 102 is added, the less the new storage unit 102 can be filled while also meeting data striping rules. As a result, additional storage units 102 may be added at a less-than-optimal rate.

Certain embodiments of the present disclosure involve techniques for rebalancing data in connection with non-rebalancing operations, as will be described in more detail below.

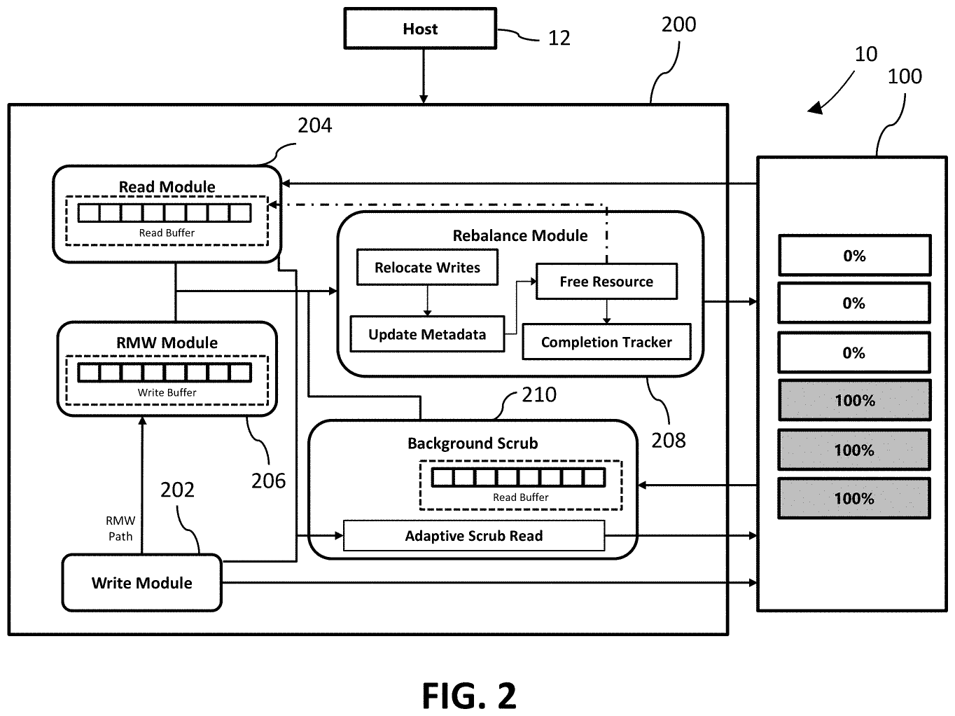

FIG. 2 shows a data storage system 10 that includes the data storage sub-system 100 and data storage control system 200 (hereinafter “the control system 200”). The control system 200 manages and controls the timing and priority of various data processes such as read requests, write requests, data balancing operations, and background scrub operations. Although only one data storage sub-system 100 is shown in FIG. 2, the control system 200 may manage and control data processes for multiple separate data storage sub-systems. Further, as noted above, the various storage units 102 of the data storage sub-system 100 may be physically distributed or separate from each other or they may be positioned in the same server rack.

The control system 200 includes several different modules, which may take the form of separate but interrelated sets of logic (e.g., firmware and its instructions). In certain embodiments, the control system 200 includes circuitry such as one or more field-programmable gate arrays (FPGAs), application-specific integrated circuits (ASICs), application processors, microcontrollers, microprocessors, or a combination thereof. These circuits can include or be coupled to memory that stores the logic/instructions for carrying out the various functions described below. As one specific example, the control system 200 may include computer-readable instructions/code for execution by a processor (e.g., a microprocessor). Such instructions/code may be stored on non-transitory computer-readable media and transferred to the processor for execution to carry out the various functions described herein.

The control system 200 includes a write module 202, which manages incoming data write requests. For example, a host system 12 may send the control system 200 a request to write new data or to modify already-written data, and the write module 202 may manage when and to where the incoming data gets written to within the data storage sub-system 100.

The control system 200 also includes a read module 204, which manages incoming data read requests. For example, the host system 12 may send the control system 200 a request to retrieve already-written data, and the read module 204 may manage when and where to retrieve the requested data within the data storage sub-system 100.

The control system 200 also includes a read-modify-write module 206, a rebalance module 208, and a background scrub module 210, which are described further below. The modules of the control system 200 work together to assist with carrying out various techniques for rebalancing data in connection with non-rebalancing operations, although additional or fewer modules may be incorporated as desired. In some embodiments, all or some of the functionality described below are consolidated into fewer modules than shown and described herein. For example, the functionality of the read-modify-write module 206 could be incorporated into the write module 202.

By performing rebalancing operations in connection with non-rebalancing operations, the data storage system 10 can accomplish at least some portion of data rebalancing without necessarily dedicating resources solely for rebalancing. For example, as will be explained more below, data can be rebalanced within the data storage system 10 in connection with performing a read-modify-write operation instead of dedicating separate resources for rebalancing. Similarly, data can be rebalanced in connection with read operations and other background operations of the data storage system 10.

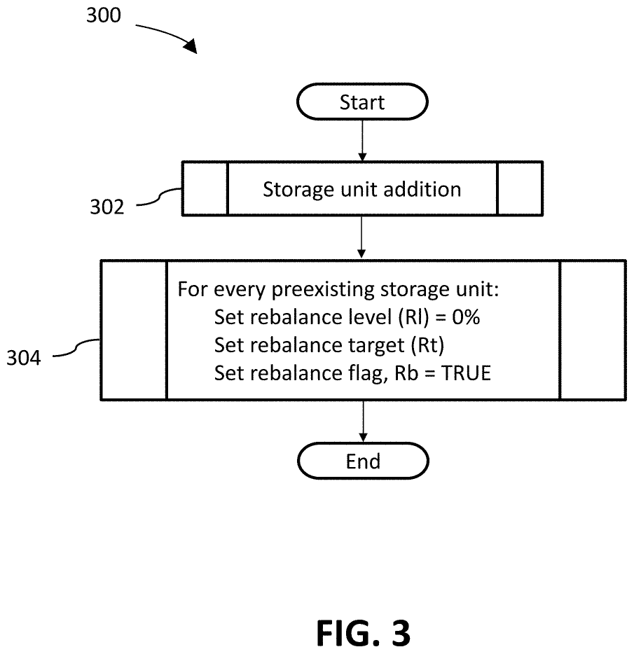

FIG. 3 shows a process 300 that can be carried out by the control system 200 when a new storage unit 102 is added to the data storage system 10 (block 302 in FIG. 3). When a new storage unit 102 is added, each preexisting storage unit 102 is associated with a rebalance flag, rebalance level, and rebalance target (block 304 in FIG. 3). The rebalance flag indicates that the given preexisting storage unit 102 either requires some amount of rebalancing or has satisfied desired rebalancing. The rebalance level indicates how close (e.g., on a scale of 0-100%) the storage unit 102 is to meeting the rebalance target. Once the rebalance target is met, the rebalance flag is changed from “true” to “false,” and the storage unit 102 is no longer accessed for rebalancing data to the new storage unit 102. Although the flags described above and below are denoted as being “true” or “false” other designations can be used.

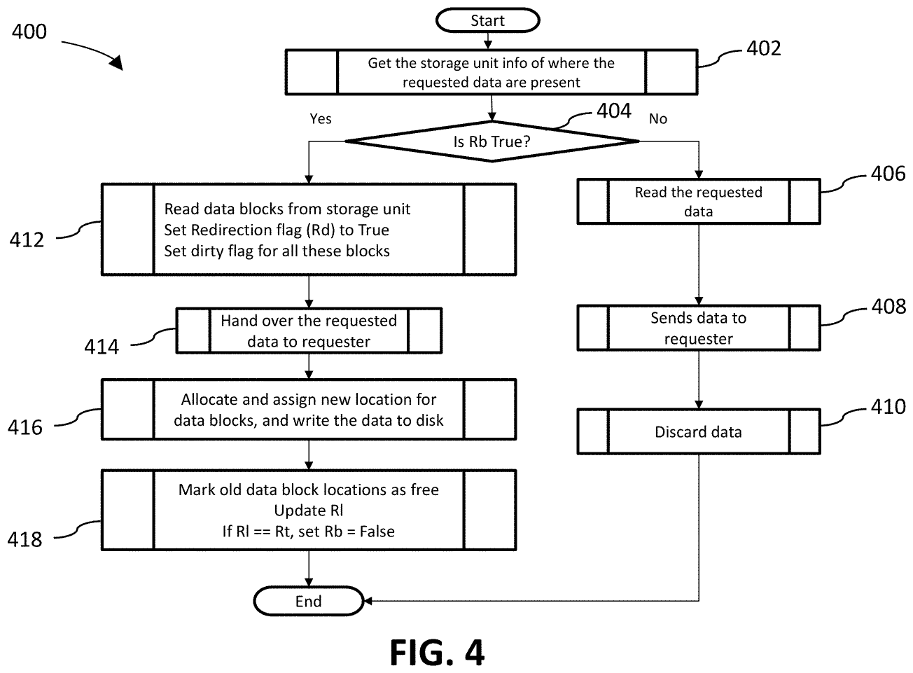

FIG. 4 shows a process 400 that can be carried out by the control system 200 in response to the data storage system 10 receiving a read command (e.g., from the host system 12). At a high-level, instead of simply locating and retrieving the requested data, the control system 200 performs a rebalancing operation by at least beginning the process for relocating the requested data to a new storage unit 102. The process 400 can be carried out, at least in part, by the read module 204 of the control system 200.

The process 400 begins when a read command is received by the data storage system 10. The control system 200 identifies where the requested data is stored (block 402 in FIG. 4). For example, the control system 200 identifies which storage unit 102 contains the requested data and the logical address of the requested data within the storage unit 202. Next, the control system 200 determines whether a rebalance flag (referred to as “Rb” in FIG. 4) assigned to that storage unit 102 is set to “true” (block 404 in FIG. 4). If the rebalance flag is set to “false,” the control system 200 reads the requested data (block 406 in FIG. 4), sends the requested data to the requester (block 408 in FIG. 4), and then discards the requested data from caches (block 410 in FIG. 4). Blocks 406-410 outline the typical process for responding to a read command.

If the rebalance flag is set to “true,” the control system 200 reads data (including at least the requested data) from the storage unit 102 (block 412 in FIG. 4). In embodiments using an object storage architecture, the control system 200 reads all data (e.g., all data blocks) in the storage unit 102 associated with the requested object. Block 412 also includes setting a redirection flag to “true.” A redirection flag is associated with individual data blocks or larger sets of data and indicates that the associated data should be directed to another storage unit 102. Block 412 also includes setting another flag, which is referred to as a “dirty flag” in FIG. 4, to “true.” Like the redirection flag, the dirty flag is associated with individual data blocks or larger sets of data. The dirty flag indicates that the associated data should be written back to a storage unit 102. As such, once a next batch of data is to be written to the associated storage unit 102, the flagged data can be written in connection with the batch of data. Until the flagged data is written to the new storage unit 102, the flagged data can be stored to memory.

Next, or in parallel, the requested data is sent to the requester (block 414 in FIG. 4). Block 416 notes that the data read from the storage unit 102 in block 412 is then assigned and written to one or more new locations (e.g., a different storage unit 102). The old data block locations are marked as being free and then the rebalance level of the former storage unit 102 is updated (block 418 in FIG. 4). If the desired rebalance level is met, the rebalance flag is set to “false” such that the storage unit 102 is not accessed for rebalancing until the rebalance flag is changed back to “true.”

As noted above, the process 400 involves performing a data rebalancing operation in connection with performing a read operation (e.g., responding to a read command). The data rebalancing operation uses the read operation's reading of requested data to start the process of distributing the requested data to a new storage unit 102. As such, the data rebalancing operation takes advantage of resources already being utilized for a non-rebalancing operation (e.g., input/output already being utilized). This can save overall resources (e.g., input/output resources) of the data storage system 10 while accomplishing the benefits of rebalancing data within the data storage system.

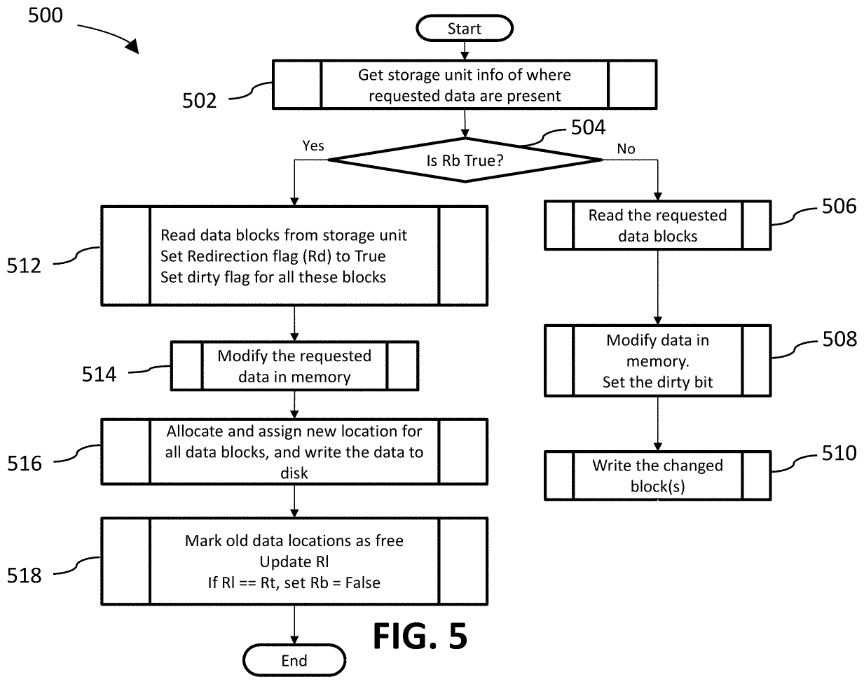

FIG. 5 shows a process 500 that can be carried out by the control system 200 in response to the data storage system 10 receiving a read-modify-write command (e.g., from the host system 12). At a high-level, instead of simply locating, reading, and modifying the requested and modified data, the control system 200 performs a rebalancing operation by at least beginning the process for relocating the requested data to a new storage unit 102. Put another way, the control system 200 identifies a new location for writing back the modified data instead of writing back the modified data to the original storage unit 102. The process 500 can be carried out, at least in part, by the read-write-modify module 206 of the control system 200.

The process 500 begins when a read-modify-write command is received by the data storage system 10. The control system 200 identifies where the requested data is stored (block 502 in FIG. 5). For example, the control system 200 identifies which storage unit 102 contains the requested data and the logical address of the requested data within the storage unit 102. Next, the control system 200 determines whether a rebalance flag (referred to as “Rb” in FIG. 5) assigned to that storage unit 102 is set to “true” (block 504 in FIG. 5). If the rebalance flag is set to “false,” the control system 200 reads the requested data (block 506 in FIG. 5), modifies the requested data to the requester and sets the “dirty bit” (block 508 in FIG. 5), and then writes the modified data blocks back to the same location in the storage unit 102 (block 510 in FIG. 5). Blocks 506-510 outline the typical process for responding to a read-modify-write command.

If the rebalance flag is set to “true,” then the control system 200 reads data (including the requested data) from the storage unit 102 (block 512 in FIG. 5). In certain embodiments, the control system 200 reads all data (e.g., all data blocks) of the storage unit 102. Block 512 also includes setting a redirection flag to “true,” and setting another flag, which is referred to as a “dirty flag” in FIG. 5, to “true.” Like the redirection flag, the dirty flag is associated with individual data blocks or larger sets of data.

Next, the requested data block is modified (e.g., modified and saved in memory) (block 514 in FIG. 5). Block 516 notes that the data read from the storage unit 102 in block 512 is then assigned and written to one or more new locations (e.g., a different storage unit 102). The old data block locations are marked as being free and then the rebalance level of the former storage unit 102 is updated (block 518 in FIG. 5). If the desired rebalance level is met, the rebalance flag is set to “false” such that the storage unit 102 is not accessed for rebalancing until the rebalance flag is changed back to “true.”

As noted above, the process 500 involves performing a data rebalancing operation in connection with performing a read-modify-write operation (e.g., responding to a partial-write command). The data rebalancing operation uses the read-modify-write operation's reading and modifying of requested data to start the process of distributing the requested data to a new storage unit 102. As such, the data rebalancing operation takes advantage of resources already being utilized for a non-rebalancing operation. This can save overall resources of the data storage system 10 while accomplishing the benefits of rebalancing data within the data storage system 10.

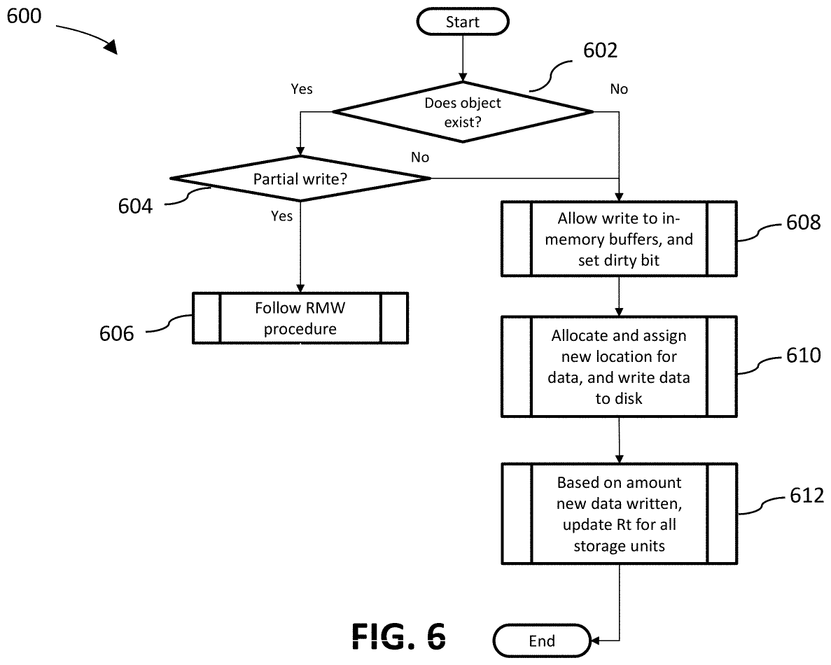

FIG. 6 shows a process 600 that can be carried out by the control system 200 in response to the data storage system 10 receiving a write command (e.g., from the host system 12). The process 600 can be carried out, at least in part, by the write module 202 of the control system 200. In short, new data being written to the data storage system 10 is written to new storage capacity and the rebalance metadata is updated to reflect this new data.

The process 600 begins when a write command is received by the data storage system 10. The control system 200 determines whether, if in the context of an object storage architecture or file system architecture, an object and file already exist (block 602 in FIG. 6). If the object does exist, then the control system 200 determines whether the write is a partial write (block 604 in FIG. 6). For example, a partial write involves a write command with writing some data that already exists in the data storage system 10. If write command involves a partial write, the control system 200 follows the read-modify-write process 500 of FIG. 5 (block 606 in FIG. 6).

If the object does not exist already or does not involve a partial write, the to-be-written data is initially written to a memory buffer and the “dirty bit” associated with the data is set (block 608 in FIG. 6). Next, or in parallel, a location in one of the new storage units 102 is assigned and the data is written to that location (block 610 in FIG. 6). Because the data is written to one of the new storage units 102, the rebalance threshold (Rt) for the preexisting storage units 102 is updated based on the amount of data written to the new storage unit 102 (block 612 in FIG. 6). If this update results in a desired rebalance level being met, the rebalance flag for a given storage unit 102 is set to “false” such that the storage unit 102 is not accessed for rebalancing until the rebalance flag is changed back to “true.”

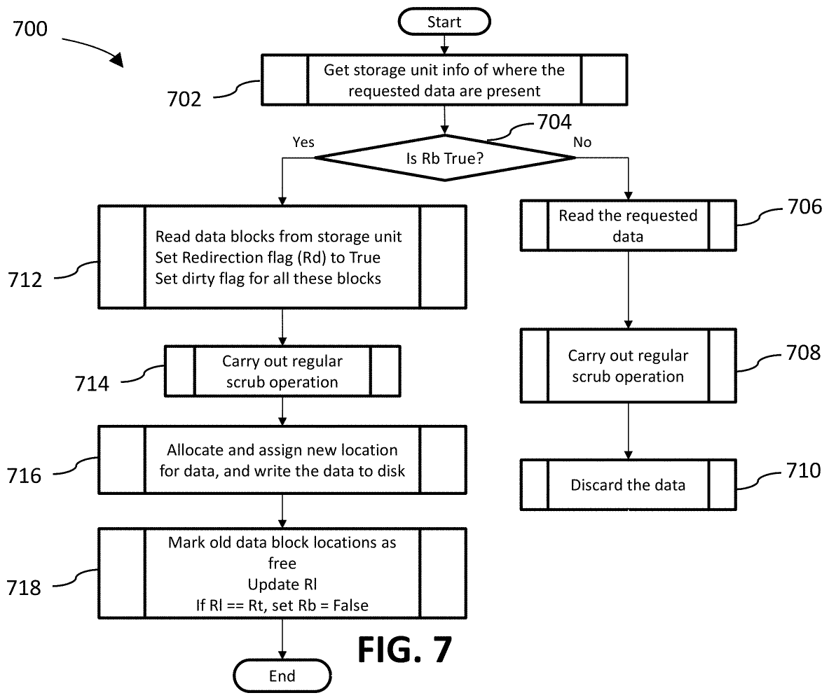

FIG. 7 shows a process 700 that can be carried out by the control system 200 in conjunction with carrying out a background data scrub operation. The process 700 can be carried out, at least in part, by the background scrub module 210 of the control system 200. In certain embodiments, a background scrub operation is scheduled periodically.

The process 700 begins when the control system 200 determines that a background scrub operation will be initiated. The control system 200 identifies which storage unit 102 will be scrubbed (block 702 in FIG. 7). Next, the control system 200 determines whether a rebalance flag (referred to as “Rb” in FIG. 7) assigned to that storage unit 102 is set to “true” (block 704 in FIG. 7). If the rebalance flag is set “false,” the control system 200 reads the requested data (block 706 in FIG. 7), carries out a regular scrub operation (block 708 in FIG. 7), and then discards the data (block 710 in FIG. 7). A regular scrub operation can, for example, scan data and determine whether certain data is corrupt and/or whether certain data can be marked for deletion.

If the rebalance flag is set to “true,” the control system 200 reads data (including at least the requested data) from the storage unit 102 (block 712 in FIG. 7). In certain embodiments, the control system 200 reads all data (e.g., all data blocks) of the storage unit 102. Block 712 also includes setting a redirection flag to “true,” and setting another flag, which is referred to as a “dirty flag” in FIG. 7, to “true.” Like the redirection flag, the dirty flag is associated with individual data blocks or larger sets of data.

Next, the control system 200 carries out a regular scrub operation (block 714 in FIG. 7), which involves reading data from the storage unit 102. For each of the scrubbed data blocks, the control system 200 assigns and writes the scrubbed data to one or more new locations (e.g., a different storage unit 102) (block 716 in FIG. 7). The old data block locations are marked as being free and then the rebalance level of the former storage unit 102 is updated (block 718 in FIG. 7). If the desired rebalance level is met, the rebalance flag is set to “false” such that the storage unit 102 is not accessed for rebalancing until the rebalance flag is changed back to “true.”

As noted above, the process 700 involves performing a data rebalancing operation in connection with performing a background scrub operation. The data rebalancing operation uses the background scrub operation's reading of certain data to start the process of distributing the read data to a new storage unit 102. As such, the data rebalancing operation takes advantage of resources already being utilized for a non-rebalancing operation. This can save overall resources of the data storage system 10 while accomplishing the benefits of rebalancing data within the data storage system 10.

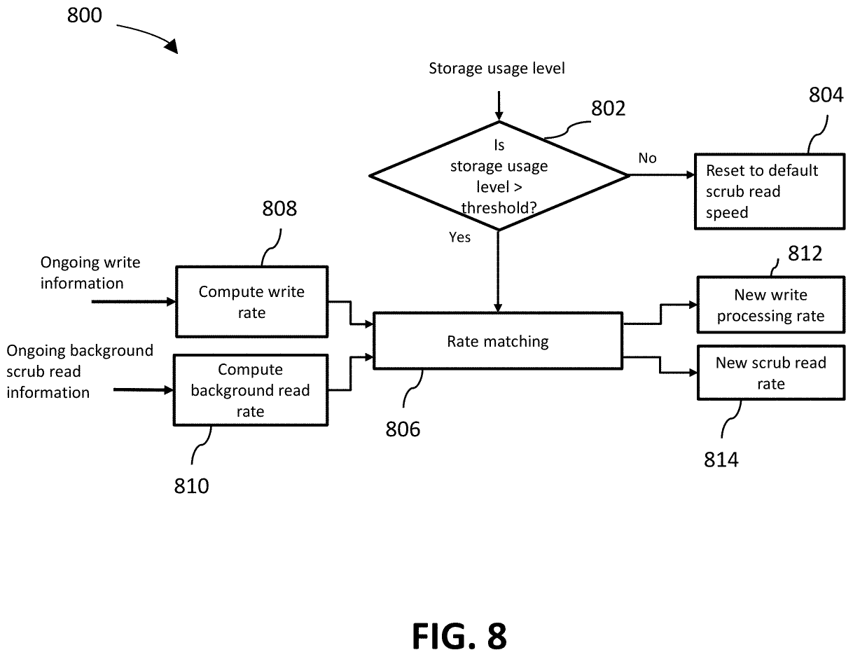

FIG. 8 shows another process 800 that can be carried out by the control system 200 in conjunction with carrying out a background data scrub operation. The process 800 can be carried out, at least in part, by the background scrub module 210 of the control system 200. In short, the background scrub module 210 can include logic for adapting various rates (e.g., inputs/outputs per second) during background scrub operations.

The process 800 of FIG. 8 can help reconcile competing demands for compute and storage resources of the data storage system 10. For example, when the host system 12 has transmitted a large write command (e.g., writing a large object/file or set of objects/files), the data storage system 10 will work to complete the write command, which may require a continuous write operation that will last for a relatively long period of time. This continuous write operation, however, can delay rebalancing operations because the data storage system's resources are being utilized for the continuous write operation and not for rebalancing operations.

The process 800 helps reconcile these competing demands by adjusting the rate of background scrub read operations and also adjusting the rate of incoming write operations. As will be described in more detail below, the reconciliation involves attempting to match the rate of the two competing operations.

The process 800 begins with determining whether a storage usage level of a given storage unit 102 is above a threshold (block 802 in FIG. 8). As one example, if the incoming commands are 50% or more write commands (as opposed to read commands), the storage use level may be above the threshold. If the storage usage level is not above the threshold, the background scrub process maintains its default read rate (block 804 in FIG. 8).

If the storage usage level is above the threshold, the control system 200 attempts to match the read rate of the background scrub operation with the write rate of the contemporaneous write operation (block 806 in FIG. 8). For example, the control system 200 can compute the current or commanded write rate (block 808 in FIG. 8) and also compute the current or commanded background scrub read rate (block 810 in FIG. 8). In response to the computed rates, the control system 200 can adjust the rates such that they are similar rates (e.g., similar input/output operations per second). For example, the rates may be set such that the rate of addition of data to the preexisting storage units 102 substantially matches the rate of data being transferred to the new storage units 102. This can help avoid the preexisting storage units 102 from filling up too quickly. The rate of an ongoing write command can be adjusted down (block 812 in FIG. 8), and the rate of an ongoing or planned background scrub read can be adjusted or set to that of the write command (block 814 in FIG. 8).

Referring back to FIG. 2, the rebalance module 208 can include memory for storing data (e.g., metadata) relating to the rebalancing operations. For example, the rebalance module 208 can store the current status of the various flags, amount of data to be rebalanced, amount of data that has been rebalanced, among other things for each given storage unit 102. As another example, the rebalance module 208 can update (e.g., atomically update) metadata regarding locations and cleanup of old metadata for relocated objects/files. The rebalance module 208 can also manage allocation of the various buffer memories of the other modules of the control system 200.

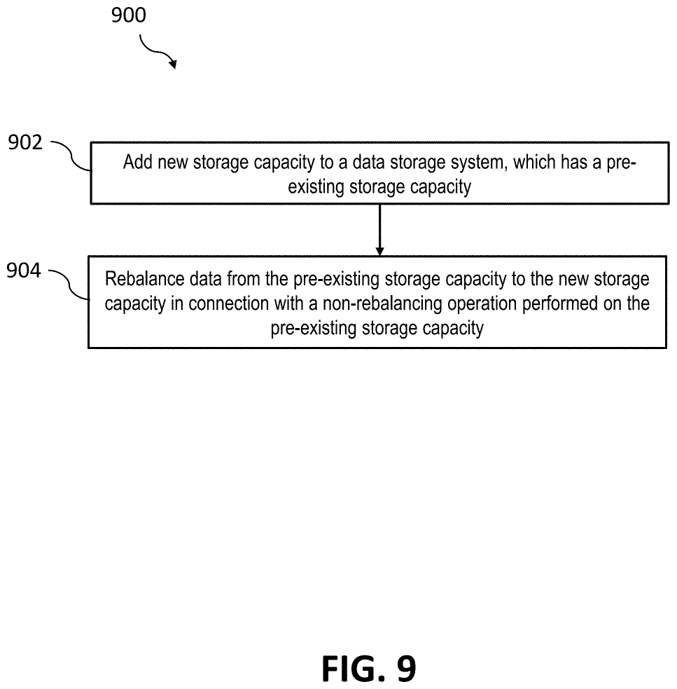

Given the descriptions above, the control system 200 and its components can carry out various methods for rebalancing data. FIG. 9 outlines one example of such a method 900. The method 900 includes adding new storage capacity to a data storage system, which has a pre-existing storage capacity (block 902 in FIG. 9). In certain embodiments involving a virtual data storage system, the new storage capacity includes a new virtual storage node, and the pre-existing storage capacity includes multiple pre-existing virtual storage nodes. In certain embodiments, the new storage capacity includes a new enclosure with multiple new data storage devices, and the pre-existing storage capacity includes a pre-existing enclosure with multiple pre-existing data storage devices. For example, the new enclosure could be a drawer or stationary enclosure that is added to a server rack that holds the pre-existing enclosure.

The method 900 also includes rebalancing data from the pre-existing storage capacity to the new storage capacity in connection with a non-rebalancing operation performed on the pre-existing storage capacity (block 904 in FIG. 9). In certain embodiments, the non-rebalancing operation is a read operation that includes retrieving and sending the requested data to a host, and the rebalancing operation includes writing the requested data to the new storage capacity. In certain embodiments, the non-rebalancing operation is a read-modify-write operation, and the rebalancing operation includes reading data from the pre-existing storage capacity, modifying the data, and writing the modified data to the new storage capacity. In certain embodiments, the non-rebalancing operation is a write operation associated with new data, and the rebalancing operation includes writing the new data to the new storage capacity and updating a rebalance target value for the pre-existing storage capacity. In certain embodiments, the non-rebalancing operation is a background scrub operation, and the rebalancing operation includes writing—to the new storage capacity—data from the pre-existing storage capacity that has been scrubbed. In the embodiments described above, an address associated with the data from the pre-existing storage capacity is marked as free in response to the rebalancing operation.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

1. A method comprising:
adding new storage capacity to a data storage system, which has a pre-existing storage capacity; and
rebalancing data from the pre-existing storage capacity to the new storage capacity in connection with a non-rebalancing operation performed on the pre-existing storage capacity.

2. The method of claim 1, wherein the non-rebalancing operation is a read operation that includes retrieving the requested data and sending the requested data to a host, wherein the rebalancing operation includes writing the requested data to the new storage capacity.

3. The method of claim 2, wherein an address associated with the requested data and the pre-existing storage capacity is marked as free after the read operation has been completed.

4. The method of claim 1, wherein the non-rebalancing operation is a read-modify-write operation, wherein the rebalancing operation includes reading data from the pre-existing storage capacity, modifying the data, and writing the modified data to the new storage capacity.

5. The method of claim 4, wherein an address associated with the read data and the pre-existing storage capacity is marked as free in response to the rebalancing operation.

6. The method of claim 1, wherein the non-rebalancing operation is a write operation associated with new data, wherein the rebalancing operation includes writing the new data to the new storage capacity and updating a rebalance target value for the pre-existing storage capacity.

7. The method of claim 6, wherein rebalance target values for each storage unit of the pre-existing storage capacity is updated.

8. The method of claim 1, wherein the non-rebalancing operation is a background scrub operation, wherein the rebalancing operation includes writing, to the new storage capacity, data from the pre-existing storage capacity that has been scrubbed.

9. The method of claim 8, wherein an address associated with the scrubbed data and the pre-existing storage capacity is marked as free in response to the rebalancing operation.

10. The method of claim 8, further comprising:
lowering a current write rate towards a read rate of to-be-scrubbed data.

11. The method of claim 1, wherein the new storage capacity includes a new virtual storage node, where the pre-existing storage capacity includes multiple pre-existing virtual storage nodes.

12. The method of claim 1, wherein the new storage capacity includes a new enclosure with multiple new data storage devices, where the pre-existing storage capacity includes a pre-existing enclosure with multiple pre-existing data storage devices.

13. A non-transitory computer readable medium storing code representing a plurality of processor-executable instructions, the code comprising code to cause a processor to:
rebalance data from pre-existing storage capacity to new storage capacity in connection with a non-rebalancing operation performed on the pre-existing storage capacity.

14. The non-transitory computer readable medium of claim 13, wherein the non-rebalancing operation is a read operation that includes retrieving the requested data and sending the requested data to a host, wherein the rebalancing operation includes writing the requested data to the new storage capacity.

15. The non-transitory computer readable medium of claim 13, wherein the non-rebalancing operation is a read-modify-write operation, wherein the rebalancing operation includes reading data from the pre-existing storage capacity, modifying the data, and writing the modified data to the new storage capacity.

16. The non-transitory computer readable medium of claim 13, herein the non-rebalancing operation is a write operation associated with new data, wherein the rebalancing operation includes writing the new data to the new storage capacity and updating a rebalance target value for the pre-existing storage capacity.

17. The non-transitory computer readable medium of claim 13, wherein the non-rebalancing operation is a background scrub operation, wherein the rebalancing operation includes writing, to the new storage capacity, data from the pre-existing storage capacity that has been scrubbed.

18. The non-transitory computer readable medium of claim 17, wherein the code further causes the processor to: adjust a rate of a writing operation and adjust a read rate of the background scrub operation to be substantially equal.

19. The non-transitory computer readable medium of claim 13, wherein the code further causes the processor to: mark as free an address associated with the requested data and the pre-existing storage capacity after the non-rebalancing operation has been completed.

20. A data storage system comprising:
pre-existing data storage capacity;
new data storage capacity; and
a control system including circuitry with logic programmed to rebalance data from the pre-existing data storage capacity to the new data storage capacity in connection with a non-rebalancing operation performed on the pre-existing data storage capacity.
